(19) United States
(12) Patent Application Publication
(10) Pub. No.: US 2024/0370381 A1
(43) Pub. Date: Nov. 7, 2024

(54) ERRONEOUS-WRITING-TO-REGISTER PREVENTION CIRCUIT, MICROCONTROLLER, AND ERRONEOUS-WRITING-TO-REGISTER PREVENTION METHOD

(71) Applicants: Kabushiki Kaisha Toshiba, Tokyo (JP); Toshiba Electronic Devices & Storage Corporation, Tokyo (JP)

(72) Inventor: Kazuya SATO, Kawasaki Kanagawa (JP)

(21) Appl. No.: 18/437,033

(22) Filed: Feb. 8, 2024

(30) Foreign Application Priority Data
May 1, 2023 (JP) 2023-075728

(51) Int. Cl. G06F 12/14; G06F 9/30

(52) U.S. Cl. CPC G06F 12/1433; G06F 9/30098; G06F 2212/1052

(57) ABSTRACT

An erroneous-writing-to-register prevention circuit includes: a selection circuit configured to select any first register in relation to which erroneous write is prevented among a plurality of registers; a memory configured to store a first address of the first register; an address comparator configured to compare the first address and a second address when a write signal for a register with the second address among the plurality of registers is inputted, and to output a match signal when the first address and the second address match; and a write control circuit configured not to output the write signal to the first register in a case where the match signal is inputted once from the address comparator.

### CROSS-REFERENCE TO RELATED APPLICATIONS

This application is based upon and claims the benefit of priority from the prior Japanese Patent Application No. 2023-075728 filed on May 1, 2023; the entire contents of which are incorporated herein by reference.

### FIELD

An embodiment described herein relates generally to an erroneous-writing-to-register prevention circuit, a microcontroller including the erroneous-writing-to-register prevention circuit, and an erroneous-writing-to-register prevention method.

### BACKGROUND

With a microcontroller that controls a controlled unit such as a motor in real time, a CPU may erroneously operate due to disturbance noise or the like, and erroneous data may be written to a register.

An erroneous-writing-to-register prevention circuit according to an embodiment includes: a selection circuit configured to select any first register in relation to which erroneous write is prevented among a plurality of registers; a memory configured to store a first address of the first register; an address comparator configured to compare the first address and a second address when a write signal for a register with the second address among the plurality of registers is inputted, and to output a match signal when the first address and the second address match; and a write control circuit configured not to output the write signal to the first register in a case where the match signal is inputted once from the address comparator.

A microcontroller according to an embodiment includes a plurality of registers and an erroneous-writing-to-register prevention circuit, where the erroneous-writing-to-register prevention circuit includes a selection circuit configured to select any first register in relation to which erroneous write is prevented among the plurality of registers, a memory configured to store a first address of the first register, an address comparator configured to compare the first address and a second address when a write signal for a register with the second address among the plurality of registers is inputted, and to output a match signal when the first address and the second address match, and a write control circuit configured not to output the write signal to the first register in a case where the match signal is inputted once from the address comparator.

An erroneous-writing-to-register prevention method according to an embodiment includes: selecting any first register in relation to which erroneous write is prevented among a plurality of registers, according to settings of a user; storing a first address of the first register in a memory; comparing the first address and a second address when a write signal for a register with the second address among the plurality of registers is inputted, and outputting a match signal when the first address and the second address match; and not outputting the write signal to the first register in a case where the match signal is inputted once.

### BRIEF DESCRIPTION OF THE DRAWINGS

FIG. 1 is a configuration diagram of a microcontroller of an embodiment;

FIG. 2 is a configuration diagram of an erroneous-writing-to-register prevention circuit of the embodiment;

FIG. 3 is a configuration diagram of a write control circuit of the embodiment;

FIG. 4 is a configuration diagram of a write control circuit of a first modification;

FIG. 5 is a configuration diagram of a write control circuit of a second modification; and

FIG. 6 is a flowchart of an erroneous-writing-to-register prevention method by a microcontroller of the second modification.

### DETAILED DESCRIPTION

Hereinafter, a microcontroller 1 and an erroneous-writing-to-register prevention circuit 2 of an embodiment will be described in detail with reference to the drawings. The drawings based on the embodiment omits illustration of one or some structural elements and assignment of reference signs.

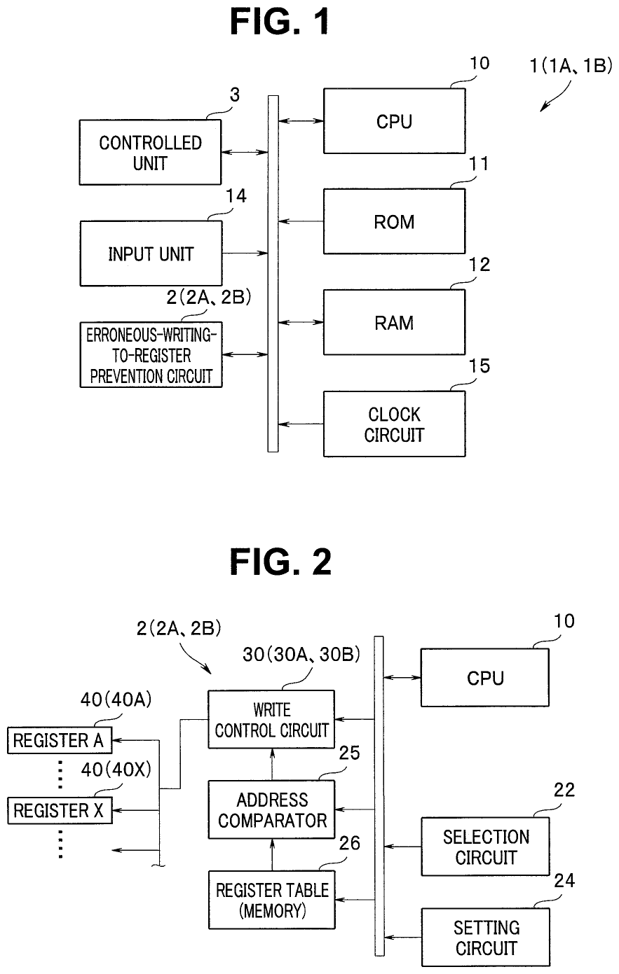

As shown in FIG. 1, the microcontroller 1 configured to control a controlled unit 3 includes a CPU 10, a ROM 11, a RAM 12, an input unit 14, a clock circuit 15, and the erroneous-writing-to-register prevention circuit 2.

The CPU 10 is a central processing unit that controls operation of the entire microcontroller 1. The ROM 11 stores programs and the like. The RAM 12 is a temporary storage unit that is used at the time of execution of a program that is read from the ROM 11. The controlled unit 3 is a motor control unit, for example. The input unit 14 is used by a user to perform setting regarding the microcontroller 1, or a feedback signal from the controlled unit 3 is inputted to the input unit 14.

The erroneous-writing-to-register prevention circuit 2 prevents erroneous write to any register that is selected by a user. In the following, a register that is selected and erroneous write to which is to be prevented will be referred to as a first register 40X (FIG. 2). A plurality of registers 40 are temporary storage units of the CPU 10, the controlled unit 3, or a functional unit not shown.

To prevent erroneous data from being written to the register due to erroneous operation of the CPU, a write protect register may be provided for each register to prevent erroneous write to the register, but a circuit scale increases.

If a manufacturer provides the write protect register only for a specific register at a time of design, an increase in the circuit scale may be prevented. Furthermore, with a microcontroller where one write protect register is provided for a clock generation circuit, for example, write to all registers (a register group) of the clock generation circuit may be allowed or prohibited by specifying an address.

However, the register which the manufacturer assumes should be protected from erroneous write and the register which is desired by the user to be protected do not always coincide. In other words, depending on a use case by the user, if an erroneous signal is written to a register for which the write protect register is not provided, a serious problem may arise.

The erroneous-writing-to-register prevention circuit 2 of the embodiment shown in FIG. 2 includes a selection circuit 22, a setting circuit 24, a memory 26 that is a register table 26, an address comparator 25, and a write control circuit 30.

The selection circuit 22 is a selection unit configured to select, from the plurality of registers 40, according to settings of the user, any one or more first registers 40X erroneous write to which is to be prevented. The setting circuit 24 is a setting unit configured to set an erroneous write prevention level according to settings of the user, for example. The selection circuit 22 and the setting circuit 24 operate according to settings inputted by the user via the input unit 14, for example.

Note that in a case where details of control set in advance by the user are stored in the RAM 12, for example, the selection circuit 22 and the setting circuit 24 operate according to the settings stored in the RAM 12. Furthermore, the details of control may be transferred to an internal memory of the write control circuit 30. In such a case, the selection circuit 22 and the setting circuit 24 operate according to the settings stored in the internal memory of the write control circuit 30.

In the case where details of control selected by the user are to be transferred to the RAM 12, the memory 26, or the internal memory of the write control circuit 30, the selection circuit 22 and the setting circuit 24 are not essential structural elements of the microcontroller 1.

The memory 26 that is a register table that stores a first address that is an address of the first register 40X may be a part of the RAM 12, or stored data in the memory 26 may be transferred to the RAM 12. For example, in the case where 32 registers are set as the first registers 40X, a 256-bit area in the RAM 12 is used as the memory 26 to store 32 first addresses, each first address having 8 bits.

The address comparator 25 is an address comparison unit configured to compare the first address and a second address when a write signal for a register with the second address among the plurality of registers is inputted, and to output a match signal in the case where the first address and the second address match.

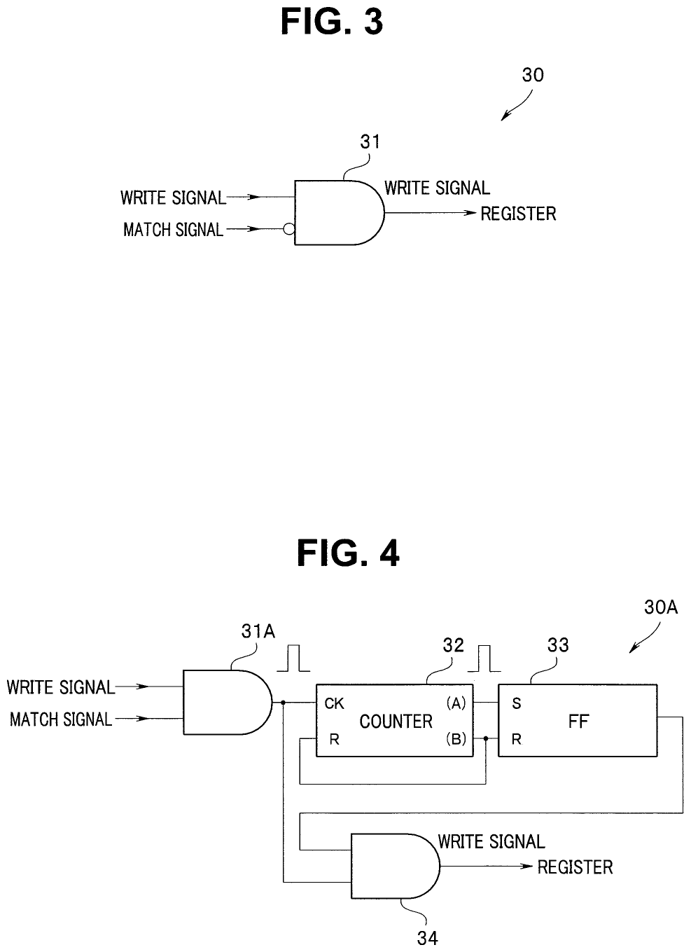

As shown in FIG. 3, the write signal is inputted to the write control circuit 30 from the CPU 10, and the match signal is inputted to the write control circuit 30 from the address comparator 25. The write control circuit 30 is a write control unit configured by a gating circuit 31 that does not output the write signal to the first register 40X in a case where the match signal is inputted. The gating circuit 31 is an AND circuit to which an inverted signal of the match signal is inputted.

The erroneous-writing-to-register prevention circuit 2 prohibits writing to the register, based on the match signal related to an address that is accessed by the CPU 10 and a register address that is registered in the register table 26.

An erroneous-writing-to-register prevention method includes selecting any first register 40X in relation to which erroneous write is to be prevented among the plurality of registers 40, according to settings of a user, storing the first address of the first register 40X in the memory 26, comparing the first address and the second address when a write signal for a register with the second address among the plurality of registers is inputted, and outputting the match signal when the first address and the second address match, and not outputting the write signal to the first register 40X in a case where the match signal is inputted once.

Even when the CPU 10 outputs the write signal for the first register 40X with respect to which erroneous write due to erroneous operation is to be prevented, write to the first register 40X is not performed thanks to the erroneous-writing-to-register prevention circuit 2. The microcontroller 1 and the erroneous-writing-to-register prevention circuit 2 may prevent erroneous write to any register according to use environment of the user, without increasing the circuit scale.

In relation to a register for which erroneous write prevention is not set (such as a register 40A), the match signal is not outputted from the address comparator 25, and it goes without saying that a normal writing operation is performed. Moreover, the user is able to perform deletion, re-registration, and registration of another address in relation to the first register 40X.

### <Modifications>

Microcontrollers 1A, 1B and erroneous-writing-to-register prevention circuits 2A, 2B of first and second modifications are similar to the microcontroller 1 and the erroneous-writing-to-register prevention circuit 2 of the embodiment, and same structural elements will be denoted by same reference signs and description will be omitted.

With the microcontroller 1, neither erroneous write nor write by normal operation is performed in relation to the first register 40X for which erroneous write prevention is set. In other words, the first register 40X is registered as a write prohibited register.

In contrast, with the microcontrollers 1A, 1B of the modifications, the first register 40X is a write limit register where erroneous write by erroneous operation of the CPU 10 or the like is prevented, but writing by normal operation of the CPU 10 is allowed.

### <First Modification>

For example, in the case of performing write to the first register 40X for which erroneous write prevention is set, the CPU 10 of the microcontroller 1A outputs the write signal for the first register 40X twice, successively over an interval of a first period of time T1. Even in the case of a write signal for the first register 40X for which erroneous write prevention is set, if the write signal is inputted twice successively, a write control circuit 30A outputs the write signal to the register 40X with the first address. In other words, the write control circuit 30A determines erroneous operation in relation to a write signal that is inputted only once, and determines normal operation in relation to a write signal that is inputted twice successively while specifying a same address. In other words, the write control circuit 30A determines that a write signal for a register with the same address would not be inputted twice successively in the case of erroneous operation.

The write control circuit 30A of the microcontroller 1A prevents erroneous write to any register for which erroneous write prevention is set by the user, but performs write based on normal operation.

Note that the setting circuit 24 of the erroneous-writing-to-register prevention circuit 2A of the microcontroller 1A is desirably able to set, in relation to execution of write based on normal operation, a predetermined number of times N until which the write signal for the same register is to be inputted successively. In other words, the predetermined number of times N is desirably variable. A greater predetermined number of times N means higher erroneous write prevention performance but longer write process. Accordingly, the predetermined number of times N is desirably two or more and five or less.

As shown in FIG. 4, the write control circuit 30A includes an AND circuit 31A, a first counter circuit 32, an RS flip-flop circuit 33, and an AND circuit 34.

When a count on the first counter circuit 32 reaches a set value A, the RS flip-flop circuit 33 is set, and the AND circuit 34 is placed in a released state. The released state means a state where the write signal can be outputted to the register when a next logical product signal of the match signal and the write signal is inputted. Accordingly, when the next logical product signal of the match signal and the write signal is inputted to the register from the AND circuit 34, data is written to the register. In other words, in the example described above, a value B is set to (value A+1). When the first counter circuit 32 reaches the value B, the RS flip-flop circuit 33 is reset, and the AND circuit 34 gates the write signal, and the write control circuit 30A is initialized to a write prohibition state.

As described above, the write control circuit 30A counts a logical product of the match signal and the write signal, releases the write prohibition state when a first predetermined number of times A is reached, and is initialized to the write prohibition state after the write signal is outputted to the register (data is written to the register) after a predetermined number of times B is reached.

For example, in the case where A=2 and B=3, write prohibition regarding the first register 40X is released by a second logical product of the register write signal and the match signal, and the register write signal is inputted to the register by a third logical product of the register write signal and the match signal.

The predetermined number of times N may be set according to settings of the user, or may be automatically set by the CPU 10 according to a reliability level that is set in advance. The reliability level is a level of erroneous operation prevention performance. For example, in the case where the reliability level is set to H (high), the predetermined number of times N may be set to a greater value than in the case where the reliability level is set to L (low).

Note that in the case of (N=3), for example, the first period of time T1 between input of a first write signal and input of a second write signal may be different from the first period of time T1 between input of the second write signal and input of a third write signal.

For example, in the case of use in an environment with a great amount of disturbance noise, the predetermined number of times N is set to a greater value than in the case of use in an environment with a small amount of disturbance noise. Furthermore, the predetermined number of times N is set to a great value in relation to a register where erroneous operation may result in serious failure or accident.

Needless to say, in relation to a register for which erroneous write prevention is not set (such as the register 40A), the match signal is not outputted and write operation is performed based on one write signal.

### <Second Modification>

The microcontroller 1B and the erroneous-writing-to-register prevention circuit 2B of the second modification are similar to the microcontroller 1A and the erroneous-writing-to-register prevention circuit 2A of the first modification, and same structural elements will be denoted by same reference signs and description will be omitted.

The setting circuit 24 of the erroneous-writing-to-register prevention circuit 2B of the microcontroller 1B is able to set, in addition to the predetermined number of times N of input of the write signal set for performing write to the first register 40X for which erroneous write prevention is set, a second period of time T2 until completion of input by the predetermined number of times N.

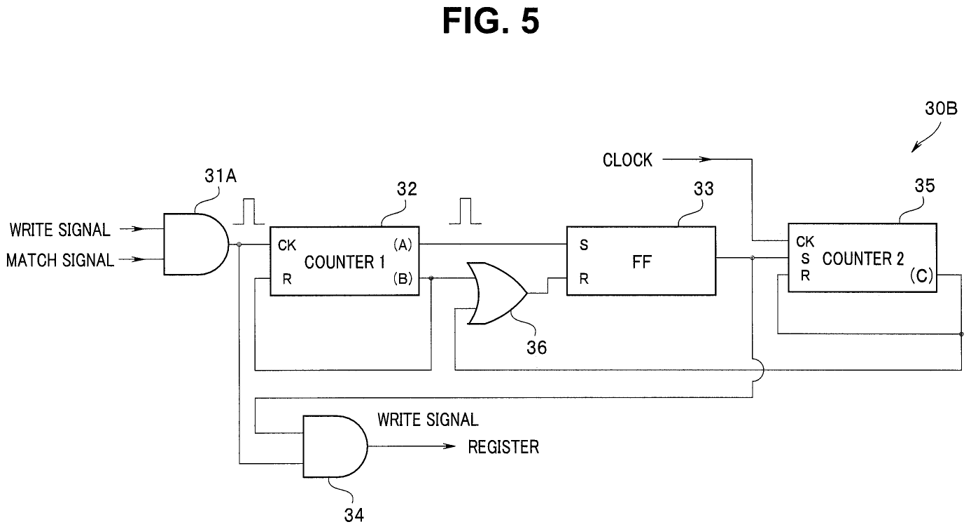

As shown in FIG. 5, a write control circuit 30B includes the AND circuit 31A, the first counter circuit 32, the RS flip-flop circuit 33, the AND circuit 34, a second counter circuit 35, and an OR circuit 36.

The second counter circuit 35 measures time based on a clock signal. When N signals are not inputted successively in the second period of time T2, the second counter circuit 35 is initialized to the register write prohibition state.

After register write prohibition is released at count A, if the number of times of write reaches the predetermined number of times N (count B) within the second period of time T2, the write signal is outputted to the first register 40X. If the number of times of write does not reach the count value B even after lapse of a time limit (the second period of time T2), register write is prohibited. In other words, the write signal is not outputted to the register. The second period of time T2 is set based on a value C that can be freely set by the second counter circuit 35.

Shorter second period of time T2 means higher erroneous write prevention performance, but a higher possibility that a write signal that should be written will not be outputted. Accordingly, the second period of time T2 is preferably equal to or greater than a minimum period of time TS that is necessary for input of N write signals and equal to or smaller than twice the minimum period of time TS, for example.

Like the predetermined number of times N, the second period of time T2 may be set according to settings of the user, or may be automatically set according to the reliability level that is set in advance.

As described above, the erroneous-writing-to-register prevention circuit 2B of the microcontroller 1B does not output the write signal unless the write signal is inputted the predetermined number of times N over the interval of the first period of time T1 and the write signal is not inputted a plurality of times within the predetermined second period of time T2.

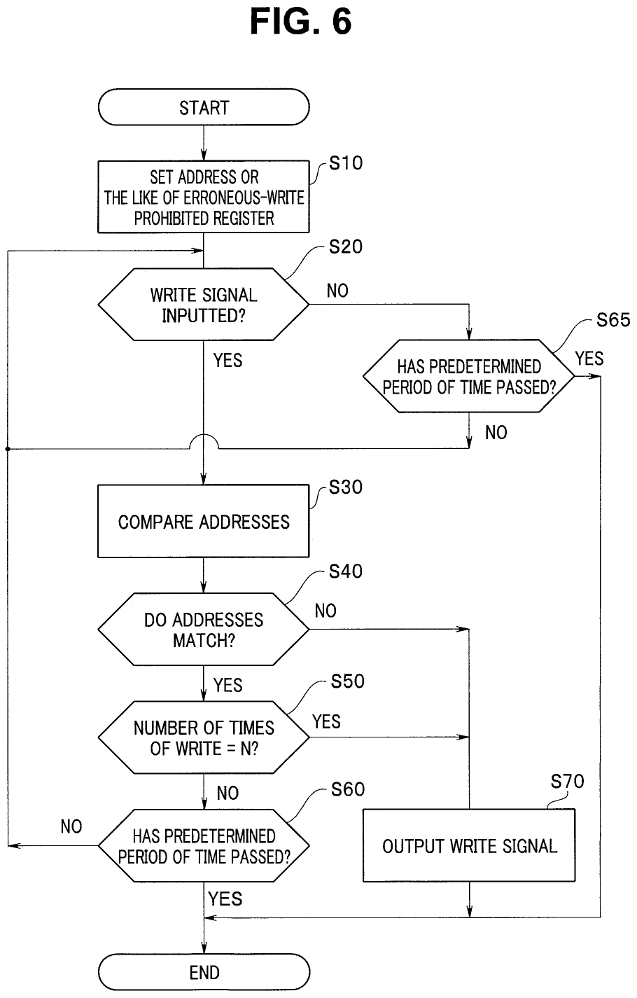

FIG. 6 shows a flowchart of an erroneous-writing-to-register prevention method performed by the microcontroller 1B of the second modification. Note that the erroneous-writing-to-register prevention method by the microcontroller of the second modification includes steps of the erroneous-writing-to-register prevention method by the microcontrollers of the embodiment and the first modification.

### <Step S10>

A register for which erroneous write prevention is to be set is selected by the user. Note that the register for which erroneous write prohibition is to be set may be set at the time of shipping from the manufacturer. The register for which erroneous write prohibition is set by the manufacturer is stored in a non-volatile storage unit, such as a ROM, that cannot be changed by the user. In contrast, a register that is freely set by the user who acquired the product is stored in a non-volatile storage unit, such as a flash memory or an EPROM, that can be rewritten by the user. In other words, with respect to a microcontroller where a register for which write prevention is to be set is stored in the memory 26 that is a non-volatile storage unit that can be rewritten by the user, it can be said that a register for which erroneous write prevention is to be set is selected by the user.

The user registers, in the memory 26, a selected register for which erroneous write prevention is to be set. Furthermore, the predetermined number of times N for writing data to the register for which erroneous write prevention is set and the second period of time T2 are also registered in the write control circuit 30B.

### <Step S20>

A write signal for one of the registers 40 and an address of the register for writing (the second address) are inputted.

### <Step S30>

The address comparator 25 compares the address of the register that is registered in the register table 26 and for which erroneous write prevention is set (the first address) and the address for the write signal (the second address).

### <Step S40>

In the case where the addresses do not match (NO), the write control circuit 30B outputs, in step S70, the write signal to the register with the second address.

### <Step S50>

In the case where the addresses match (S40: YES), or in other words, in the case of the write signal for the register with the first address for which erroneous write prevention is set, the write control circuit 30B determines whether the number of times of successive write to the register is the predetermined number of times N. In the case where the number of times of write is N (YES), the write control circuit 30B outputs the write signal in step S70 even in the case of the register with the second address, or in other words, the register with the first address for which erroneous write prevention is set.

### <Step S60>

In the case where the number of times of write is less than N (S50: NO), the write control circuit 30B determines whether there is a lapse of the predetermined second period of time T2 from first write.

In the case where there is a lapse of the second period of time T2 (YES), the write control circuit 30B determines that the write is not normal write, and ends a series of processes for the write. Then, a write process for a new register with a different address is started from step S20.

In the case where there is no lapse of the second period of time T2 (NO), the write control circuit 30B proceeds again to the input step (S20) for the write signal for the register with the same address. Note that also in S20, in the case where there is a lapse of the second period of time T2 (step S65: YES), the write control circuit 30B determines that the write is not normal write intended by the user, and ends the series of processes for the write.

Furthermore, although not shown, also in a case where a write signal for a register with an address that is different from the address with respect to which the number of times of write is counted is inputted in step S20, the write control circuit 30B ends writing to the register with the address with respect to which the number of times of write is counted.

Note that at least one of functional units of the microcontroller 1 and the like in respective embodiments may be configured by an internal circuit of a processor that is operated by software, or may be configured by a dedicated hardware circuit.

Moreover, the controlled unit 3 is not limited to a motor control unit, and is not limited in terms of use.

While certain embodiments of the invention have been described, these embodiments have been presented by way of example only, and are not intended to limit the scope of the invention. The novel embodiments may be embodied in various other modes, and various omissions, substitutions, and changes may be made without departing from the gist of the invention. The embodiments and the modifications fall within the scope or gist of the invention, and within the invention described in the claims and their equivalents.

What is claimed is:

1. An erroneous-writing-to-register prevention circuit comprising:
a selection circuit configured to select any first register in relation to which erroneous write is prevented among a plurality of registers;
a memory configured to store a first address of the first register;
an address comparator configured to compare the first address and a second address when a write signal for a register with the second address among the plurality of registers is inputted, and to output a match signal when the first address and the second address match; and
a write control circuit configured not to output the write signal to the first register in a case where the match signal is inputted once from the address comparator.

2. The erroneous-writing-to-register prevention circuit according to claim 1, wherein the first register is selected according to settings of a user.

3. The erroneous-writing-to-register prevention circuit according to claim 2, further comprising a setting circuit configured to set a predetermined number of times until which the write signal is successively inputted to the write control circuit, wherein
the write control circuit outputs the write signal when the write signal and the match signal are inputted successively the predetermined number of times.

4. The erroneous-writing-to-register prevention circuit according to claim 3, wherein the predetermined number of times is set according to settings of a user.

5. The erroneous-writing-to-register prevention circuit according to claim 3, wherein the predetermined number of times is automatically set according to a reliability level that is set in advance.

6. The erroneous-writing-to-register prevention circuit according to claim 3, wherein
the write signal is successively inputted the predetermined number of times over an interval of a first period of time, and
the write control circuit outputs the write signal when the write signal and the match signal are successively inputted the predetermined number of times within a predetermined second period of time.

7. The erroneous-writing-to-register prevention circuit according to claim 4, wherein
the write signal is successively inputted the predetermined number of times over an interval of a first period of time, and
the write control circuit outputs the write signal when the write signal and the match signal are successively inputted the predetermined number of times within a predetermined second period of time.

8. The erroneous-writing-to-register prevention circuit according to claim 5, wherein
the write signal is successively inputted the predetermined number of times over an interval of a first period of time, and
the write control circuit outputs the write signal when the write signal and the match signal are successively inputted the predetermined number of times within a predetermined second period of time.

9. The erroneous-writing-to-register prevention circuit according to claim 8, wherein the second period of time is set according to settings of a user.

10. The erroneous-writing-to-register prevention circuit according to claim 8, wherein the second period of time is automatically set according to a reliability level that is set in advance.

11. A microcontroller comprising a plurality of registers and an erroneous-writing-to-register prevention circuit, wherein
the erroneous-writing-to-register prevention circuit includes
a selection circuit configured to select any first register in relation to which erroneous write is prevented among the plurality of registers,
a memory configured to store a first address of the first register,
an address comparator configured to compare the first address and a second address when a write signal for a register with the second address among the plurality of registers is inputted, and to output a match signal when the first address and the second address match, and
a write control circuit configured not to output the write signal to the first register in a case where the match signal is inputted once from the address comparator.

12. An erroneous-writing-to-register prevention method comprising:
selecting any first register in relation to which erroneous write is prevented among a plurality of registers, according to settings of a user;
storing a first address of the first register in a memory;
comparing the first address and a second address when a write signal for a register with the second address among the plurality of registers is inputted, and outputting a match signal when the first address and the second address match; and
not outputting the write signal to the first register in a case where the match signal is inputted once.
